(19) United States
(12) Patent Application Publication
(10) Pub. No.: US 2026/0003111 A1
(43) Pub. Date: Jan. 1, 2026

(54) POLARIZING PLATE AND OPTICAL DISPLAY APPARATUS

(71) Applicant: SAMSUNG SDI CO., LTD., Yongin-si (KR)

(72) Inventors: Yong Un JUNG, Suwon-si (KR); Jin Woo KIM, Suwon-si (KR); Sang Hum LEE, Suwon-si (KR); Jung Hun YOU, Suwon-si (KR); Beom Deok LEE, Suwon-si (KR)

(21) Appl. No.: 19/251,535

(22) Filed: Jun. 26, 2025

(30) Foreign Application Priority Data
Jun. 27, 2024 (KR) 10-2024-0084305

(51) Int. Cl. G02B 5/30

(52) U.S. Cl. CPC G02B 5/3016

(57) ABSTRACT

Disclosed are a polarizing plate and an optical display apparatus including the same. The polarizing plate includes: a polarizer; and a retardation layer formed on one surface of the polarizer, wherein the retardation layer comprises a liquid crystal retardation layer, the liquid crystal retardation layer satisfying Formula 1 described in detail in the specification.

### CROSS-REFERENCE TO RELATED APPLICATION

The present application claims priority to and the benefit of Korean Patent Application No. 10-2024-0084305, filed on Jun. 27, 2024, in the Korean Intellectual Property Office, the entire disclosure of which is incorporated herein by reference.

### FIELD

The present disclosure relates to a polarizing plate and an optical display apparatus.

### DESCRIPTION OF THE RELATED ART

Organic light emitting device displays can suffer from deterioration in visibility and contrast due to reflection of external light. To address this problem, a polarizing plate is used. The polarizing plate realizes an antireflection function by reducing reflectivity of reflected external light. The polarizing plate fundamentally requires significant improvement in screen quality by improving black visibility at a front side thereof.

A polarizing plate is essentially composed of a polarizer and a retardation layer. Generally, the retardation layer is a bilayer type (or kind) retardation layer composed of a half-wavelength plate (HWP) layer and a quarter-wavelength plate (QWP) layer. However, the bilayer type retardation layer essentially includes a stack of the HWP layer and the QWP layer, reducing manufacturing processability of the polarizing plate while increasing the thickness of the polarizing plate. There is also a polarizing plate including a single-sheet type retardation layer. However, this polarizing plate has limited ability to reduce reflectivity at front and lateral sides.

The background technique of the present disclosure is disclosed in Korean Patent Laid-open Publication No. 10-2013-0103595 and the like.

### SUMMARY

It is an aspect of the present disclosure to provide a polarizing plate that significantly reduces a reflected color azimuthal angle color distribution (AACD) value when applied to an optical display apparatus.

In accordance with one aspect of the present disclosure, there is provided a polarizing plate.

The polarizing plate includes: a polarizer; and a retardation layer stacked on one surface of the polarizer, wherein the retardation layer includes a liquid crystal retardation layer, the liquid crystal retardation layer satisfying Formula 1:

$$5 \leq \vert ( CD ( 400 nm ) - CD ( 300 nm ) ) / 100 \vert \leq 23 , \qquad ( 1 )$$

where CD(400) is a circular dichroism value (unit: mdeg) of the liquid crystal retardation layer at a wavelength of 400 nm, and
CD(300) is a circular dichroism value (unit: mdeg) of the liquid crystal retardation layer at a wavelength of 300 nm.

In accordance with another aspect of the present disclosure, there is provided an optical display apparatus.

The optical display apparatus includes the polarizing plate set forth above.

Embodiments of the present disclosure provide a polarizing plate that significantly reduces a reflected color AACD value when applied to an optical display apparatus.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain principles of the present disclosure.

FIG. 1 is a graph depicting wavelength-dependent circular dichroism (CD) values of a liquid crystal retardation layer and the slope |(CD(400 nm)−CD(300 nm))/100| of Formula 1, in which the X-axis indicates wavelength (unit: nm) and the Y-axis indicates circular dichroism (unit: mdeg) of the liquid crystal retardation layer.

FIG. 2 shows one example of a liquid crystal alignment state of a liquid crystal retardation layer.

FIG. 3 shows another example of a liquid crystal alignment state of a liquid crystal retardation layer.

FIG. 4 is a cross-sectional view of a polarizing plate according to some embodiments of the present disclosure.

FIG. 5 is a graph showing evaluation results of reflected color values in the a* and b* color coordinates of Example 1, FIG. 6 is a graph showing evaluation results of reflected color values in the a* and b* color coordinates of Example 2, FIG. 7 is a graph showing evaluation results of reflected color values in the a* and b* color coordinates of Comparative Example 1, and FIG. 8 is a graph showing evaluation results of reflected color values in the a* and b* color coordinates of Comparative Example 3.

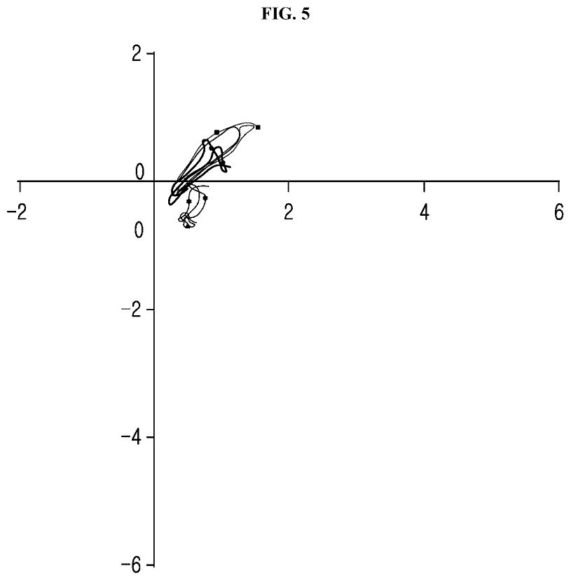

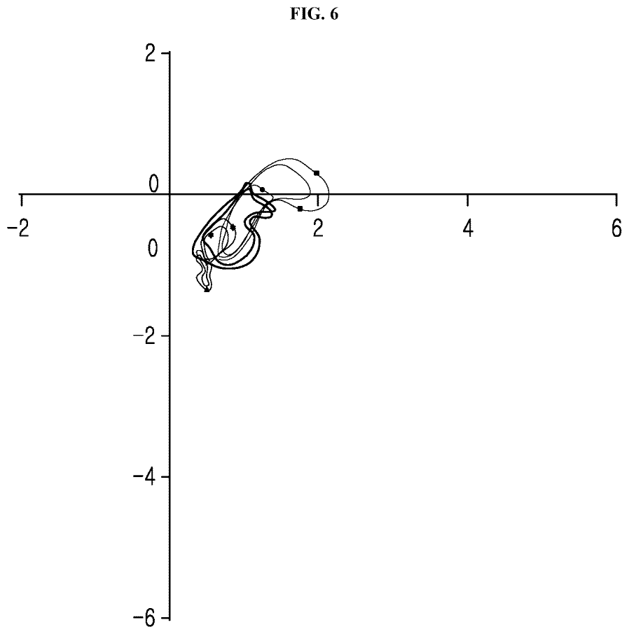

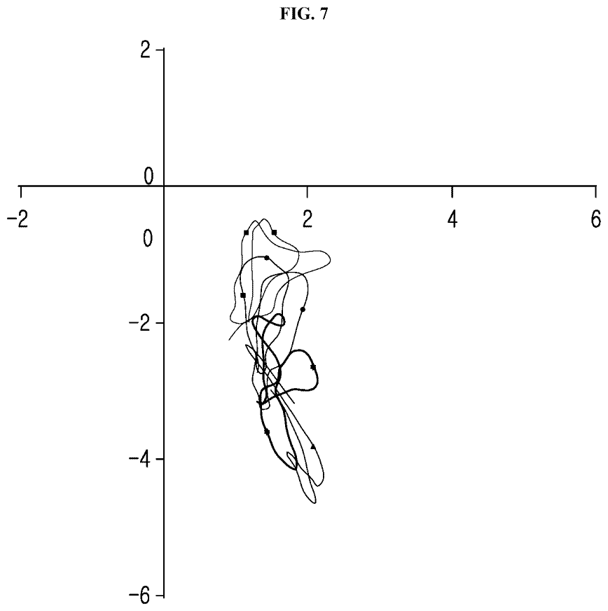

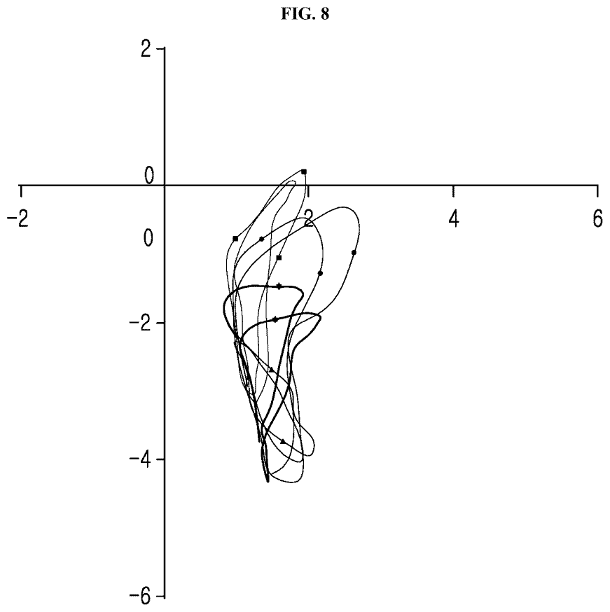

In FIG. 5 to FIG. 8, the X-axis indicates the reflected color value a* and the Y-axis indicates the reflected color value b*, ▴ is a reflected color value when θ is 8°, ★ is a reflected color value when θ is 30°, ⋅ is a reflected color value when θ is 45°, and ▪ is a reflected color value when θ is 60°, at Φ of 0 to 360°.

### DETAILED DESCRIPTION

Hereinafter, example embodiments of the present disclosure will be described in more detail with reference to the accompanying drawings such that the present disclosure can be easily implemented by a person having ordinary knowledge in the art. It should be understood that the present disclosure may be embodied in different ways and is not limited to the following embodiments.

The terminology used herein is for the purpose of describing example embodiments and is not intended to limit the present disclosure. As used herein, the singular forms “a”, “an”, and “the” are intended to include the plural forms as well, unless the context specifically indicates otherwise.

In the drawings, components unrelated to the description are omitted for clear description of the disclosure and like components will be denoted by like reference numerals throughout the specification. Although lengths, thicknesses or widths of various components may be exaggerated for understanding in the drawings, the present disclosure is not limited thereto.

Herein, spatially relative terms, such as “upper” and “lower”, are defined with reference to the accompanying drawings. Thus, it will be understood that the term “upper surface” can be used interchangeably with the term “lower surface”.

Herein, “in-plane retardation Re” and “out-of-plane retardation Rth” are represented by Equations A and B, respectively:

$$Re = ( nx - ny ) \times d , \qquad ( A )$$

$$Rth = ( ( nx - ny ) / 2 - nz ) \times d , \qquad ( B )$$

where nx, ny, and nz are the indexes of refraction of a retardation layer, as measured at a measurement wavelength in the slow axis direction, the fast axis direction and the thickness direction thereof, respectively, and d is the thickness thereof (unit: nm).

Herein, unless clearly stated otherwise, nx, ny, and nz refer to the indexes of refraction of the retardation layer in the slow axis direction, the fast axis direction, and the thickness direction at a wavelength of 550 nm, respectively.

Herein, an axis along which the index of refraction of the retardation layer in the in-plane direction attains (e.g., exhibits) a maximum level (e.g., value) will be defined as the slow axis and an axis along which the index of refraction of the retardation layer in the in-plane direction attains (e.g., exhibits) a minimum level (e.g., value) will be defined as the fast axis. The slow axis may be substantially orthogonal to the fast axis, without being limited thereto.

Herein, “circular dichroism (CD)” is a value measured for a retardation layer, which may be measured using a circular dichroism spectrometer. Specifically, CD may be measured as a difference between molar extinction coefficients ε1 and ∈r, corresponding to left- and right-circular polarization, respectively, within a wavelength region of an optically active absorption band of an optically active material. That is, the circular dichroism (chirality) is represented by Δε=ε1−εr.

Herein, a reflected color AACD (azimuthal angle color distribution) value may be measured using a DMS display measurement device (Instrument Systems Inc.) by applying a polarizing plate to an optical display apparatus. The AACD value may be measured by measuring the reflected color values a and b* (according to the CIE 1976 color space) of the optical display apparatus at polar angles θ of Aug. 30, 1945/60° and at azimuthal angles Φ of 0 to 360° in the spherical coordinate system, and obtaining a value of (a*ₘₐₓ−a*ₘᵢₙ)×(b*ₘₐₓ−b*ₘᵢₙ) to represent the degree of color dispersion at the overall azimuth angles and at each theta angle.

A polarizing plate according to some embodiments of the present disclosure may be used as an anti-reflective polarizing plate in an optical display apparatus. The optical display apparatus may include an optical display apparatus including a light emitting diode as a light source, such as an organic light emitting diode display.

According to some embodiments, the polarizing plate includes a retardation layer, wherein the retardation layer includes a liquid crystal retardation layer satisfying Formula 1:

$$5 \leq \vert ( CD ( 400 nm ) - CD ( 300 nm ) ) / 100 \vert \leq 23 , \qquad ( 1 )$$

where CD(400) is a circular dichroism value (unit: mdeg) of the liquid crystal retardation layer at a wavelength of 400 nm, and

CD(300) is a circular dichroism value (unit: mdeg) of the liquid crystal retardation layer at a wavelength of 300 nm.

The inventors of the present disclosure confirmed that, when the retardation layer applied to an anti-reflective polarizing plate is a liquid crystal retardation layer satisfying Formula 1, the polarizing plate provides a reflected color AACD value of 5 or less when applied to an optical display apparatus.

Formula 1 may become a determination standard that the reflected color AACD value is less than or equal to 5 when the anti-reflective polarizing plate including the liquid crystal retardation layer is applied to the optical display apparatus. That is, Formula 1 may serve as a criterion for determining whether the reflected color AACD value is less than or equal to 5 when the anti-reflective polarizing plate including a liquid crystal retardation layer is applied to the optical display apparatus.

If the value of |(CD(400 nm)−CD(300 nm))/100| of Formula 1 is less than 5, the reflected color AACD value may exceed 5 due to lack of (e.g., insufficient) chirality of the liquid crystal retardation layer, which results in insufficient wavelength dispersion of the liquid crystal retardation layer.

If the value of |(CD(400 nm)−CD(300 nm))/100| of Formula 1 is greater than 23, the reflected color AACD value may exceed 5 due to excessive chirality of the liquid crystal retardation layer, causing the liquid crystal retardation layer to exceed an optimal point at which the liquid crystal retardation layer can exhibit negative dispersion characteristics.

According to some embodiments, the value of |(CD(400 nm)−CD(300 nm))/100| of Formula 1 may range from 5.5 to 22.5. Within this range, the polarizing plate can provide significant reduction in reflected color AACD value and the liquid crystal retardation layer can be more easily manufactured.

Formula 1 shows a slope (percentage slope) (e.g., rate of change) between a circular dichroism value at a wavelength of 300 nm and a circular dichroism value at a wavelength of 400 nm in a graph of circular dichroism (CD) (unit: mdeg) of the liquid crystal retardation layer (Y-axis) according to wavelength (X-axis).

The inventors of the present disclosure have selected a circular dichroism value at a wavelength of 300 nm from among a plurality of wavelength values within a wavelength range. The wavelength of 300 nm is in the wavelength range providing a large circular dichroism due to chirality of liquid crystals and is close to the visible spectrum, whereby reflection characteristics of visible light by the degree of circular polarization can be inferred.

The inventors have selected a circular dichroism value at a wavelength of 400 nm from among the plurality of wavelength values within the wavelength range. The circular dichroism value at the wavelength of 400 nm is selected because the circular dichroism due to chirality of the liquid crystals approaches zero in a visible spectrum start region near the wavelength of 400 nm, which is in the wavelength range sufficiently exhibiting a slope relative to the circular dichroism value at a wavelength of 300 nm in optical design for absorbing light at a wavelength in the visible spectrum to avoid luminance loss and color distortion in an optical display apparatus.

Specifically, in the above graph (e.g., used to calculate Formula 1), the X-axis represents measurement wavelengths, in which the distance between the measurement wavelengths may be 50 nm. In the above graph, the Y-axis represents the circular dichroism value of the liquid crystal retardation layer, in which the distance between the circular dichroism values may be 500 mdeg.

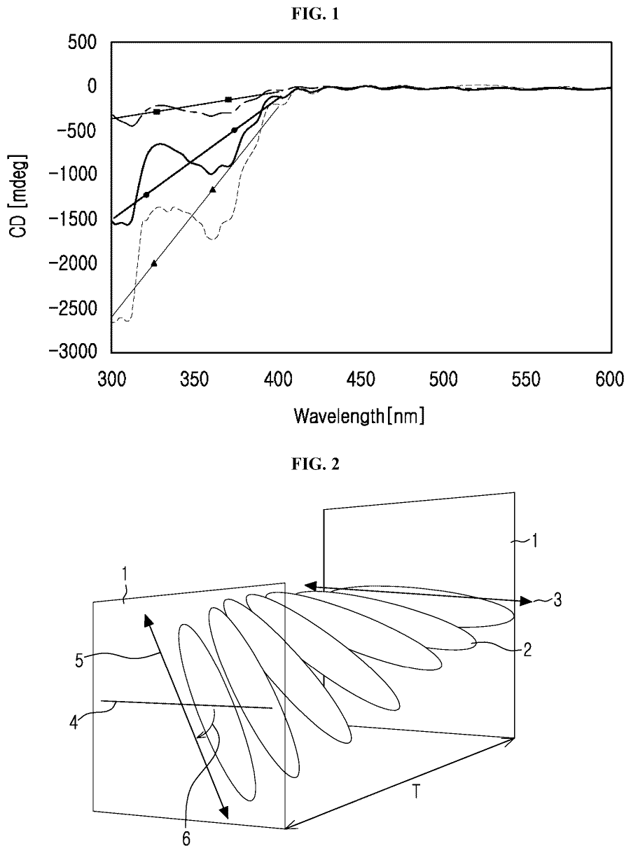

FIG. 1 is a graph depicting wavelength-dependent circular dichroism values of a liquid crystal retardation layer and |(CD(400 nm)−CD(300 nm))/100| of Formula 1, in which the X-axis indicates wavelength (unit: nm) and the Y-axis indicates circular dichroism (CD) (unit: mdeg).

Referring to FIG. 1, negative values on the Y-axis indicate the degree of transmission of right-handed polarized light, while positive values thereon indicate the degree of transmission of left-handed polarized light.

In the graph of FIG. 1, the curved lines show the wavelength-dependent circular dichroism values and the slopes of straight lines are slopes (e.g., rate of change) of circular dichroism values, which are measured at wavelengths of 300 nm and 400 nm.

According to some embodiments, the liquid crystal retardation layer may have a circular dichroism value of −2,500 mdeg to −500 mdeg, for example, −2,400 mdeg to −650 mdeg, at a wavelength of 300 nm and a circular dichroism value of −500 mdeg to 0 mdeg, for example, −200 mdeg to −50 mdeg, at a wavelength of 400 nm.

According to some embodiments, the polarizing plate includes a polarizer and a liquid crystal retardation layer stacked on one surface of the polarizer. When the polarizing plate is stacked on an optical display panel, the liquid crystal retardation layer may be disposed between the polarizer and the optical display panel.

According to some embodiments, the liquid crystal retardation layer may be disposed on a surface of the polarizer through which external light is emitted from the polarizer after entering the polarizer.

### Polarizer

The polarizer has a light absorption axis and a light transmission axis in an in-plane direction thereof, in which the light absorption axis may correspond to the machine direction (MD) of the polarizer and the light transmission axis may correspond to the transverse direction (TD) of the polarizer.

The polarizer may have a total light transmittance of 40% or more, for example, 40% to 46%, and a degree of polarization of 95% or more, for example, 95% to 99.999%. Within these ranges, the polarizing plate can exhibit improved anti-reflection performance when the polarizer is combined with the retardation layer. The terms “light transmittance” and “degree of polarization” refer to values measured in a wavelength range of 380 nm to 780 nm and reflect (e.g., indicate) visibility in the corresponding wavelength range.

The polarizer may have a thickness of 2 μm to 30 μm, for example, 4 μm to 25 μm. Within this range, the polarizer can be suitably used in the polarizing plate.

The polarizer may be directly stacked on the liquid crystal retardation layer described below through or without an adhesive layer or a bonding layer.

### Liquid Crystal Retardation Layer

The liquid crystal retardation layer satisfies Formula 1 above. Because this relation is described above, repeated description thereof will be omitted.

The liquid crystal retardation layer may have an in-plane retardation of 100 nm to 155 nm, for example, 110 nm to 145 nm, at a wavelength of 550 nm. Within this range, the liquid crystal retardation layer can secure an antireflection effect together with the polarizer.

The liquid crystal retardation layer may have a thickness of 10 μm or less, for example, 1 μm to 10 μm. Within this range, the liquid crystal retardation layer can be suitably used in the polarizing plate. In some embodiments, the liquid crystal retardation layer has a thickness of greater than 1.0 μm and less than or equal to 3.5 μm, for example, 1.1 μm to 3.5 μm. Within this range, the liquid crystal retardation layer can easily satisfy Formula 1.

The liquid crystal retardation layer may include any type or kind of liquid crystal so long as the liquid crystal retardation layer satisfies Formula 1. However, the liquid crystal retardation layer may include twisted nematic (TN) liquid crystals so as to satisfy Formula 1 while easily reaching the in-plane retardation range described above.

In some embodiments, the liquid crystal retardation layer may include a dry product and/or a cured product of a coating solution (hereinafter referred to as the “TN composition”) including a twist nematic liquid crystal compound, a chiral agent, and a polymerization initiator.

The TN composition may be a coating composition containing at least one solvent. The coating composition may further include any additional components, for example, a leveling agent, a dispersant, an antioxidant, and/or an anti-ozone agent. In addition, the coating composition may further include various dyes and pigments to absorb UV, infrared, and/or visible light. In some embodiments, viscosity modifiers, such as thickeners and fillers, may be further added to the coating composition.

The TN composition may be applied by various liquid coating methods. In some embodiments, after coating, the TN composition is polymerized or converted into a TN layer. Conversion of the TN composition may be carried out by a variety of techniques including evaporation of the solvent; heating for alignment of TN materials; crosslinking of the TN composition; or curing of the TN composition. The curing of the TN composition may be achieved through application of, for example, heat, actinic radiation, irradiation with light, such as UV, visible, or infrared light, irradiation with electron beams, a combination thereof, or similar techniques.

By way of example, the TN composition may include a twisted nematic liquid crystal compound, a polymerization initiator, and a chiral agent.

The twisted nematic liquid crystal compound may include any typical twisted nematic liquid crystal compound known to those skilled in the art.

The polymerization initiator may include a radical initiator that generates radicals, for example, by heat or light. The radical initiator serves to initiate polymerization or crosslinking of the nematic liquid crystal compound and may be selected from typical components known to those skilled in the art so long as there is no problem in terms of compatibility with the compound. The radical initiator may include at least one selected from the group consisting of, for example, 2-methyl-1-[4-(methylthio)phenyl]-2-(4-morpholinyl)-1-propanone, 2-dimethoxy-1,2-diphenylethan-1-one, 1-hydroxy-cyclohexyl-phenyl-ketone, triaryl sulfonium hexafluoroantimonate salts, diphenyl(2,4,6-trimethylbenzoyl)-phosphine oxide, and combinations thereof, without being limited thereto. In the TN composition, the radical initiator may be present in an amount of 0.1 parts by weight to 10 parts by weight relative to 100 parts by weight of the liquid crystal compound. By controlling the content of the radical initiator as described above, it is possible to induce effective polymerization and crosslinking of the liquid crystal compound while preventing property degradation due to residual initiator after polymerization and crosslinking. Herein, “parts by weight” may refer to a percentage of the weight of each component, unless specified otherwise.

The chiral agent may include an acrylic levorotatory chiral agent.

The acrylic levorotatory chiral agent may be present in an amount of 0.001 parts by weight to 10 parts by weight, for example, 0.1 parts by weight to 1 part by weight relative to 100 parts by weight of the liquid crystal compound. By controlling the content of the chiral agent as described above, it is possible to induce an effective concentration gradient of the chiral agent and effective polymerization of the liquid crystal compound.

In some embodiments, the acrylic levorotatory chiral agent may be present in an amount of 0.1 parts by weight to 0.5 parts by weight, relative to 100 parts by weight of the liquid crystal compound. Within this range, the liquid crystal retardation layer can easily satisfy Formula 1.

The TN composition may further include a solvent, as needed. The solvent may include, for example, halogenated hydrocarbons, such as chloroform, dichloromethane, tetrachloroethane, trichloroethylene, tetrachloroethylene, chlorobenzene, and the like; aromatic hydrocarbons, such as benzene, toluene, xylene, methoxybenzene, 1,2-dimethoxybenzene, and the like; alcohols and ketones, such as methanol, ethanol, propanol, isopropanol, acetone, methyl ethyl ketone, methyl isobutyl ketone, cyclohexanone, cyclopentanone, and the like; cellosolves, such as methyl cellosolve, ethyl cellosolve, butyl cellosolve, and the like; and ethers, such as diethylene glycol dimethyl ether (DEGDME), dipropylene glycol dimethyl ether (DPGDME), and the like. Furthermore, the content of the solvent is not particularly limited and may be suitably selected in consideration of coating efficiency, drying efficiency, and the like.

In addition, the TN composition may further include a surfactant. The surfactant can be distributed on the surface of the liquid crystals to make the surface of the liquid crystals uniform while stabilizing alignment of the liquid crystals such that a film surface remains uniform after formation of the TN layer, thereby improving appearance quality.

The surfactant may include, for example, a fluorocarbon-based surfactant and/or a silicone-based surfactant. The fluorocarbon-based surfactant may include, for example, Fluorad FC4430™, Fluorad FC4432™, Fluorad FC4434™, Zonyl™ (DuPont), and the silicone-based surfactant may include, for example, BYK™ (BYK-Chemie) and the like. The content of the surfactant is not particularly limited and may be suitably selected in consideration of coating efficiency, drying efficiency, and the like.

The TN layer may be formed by coating the TN composition to form a liquid crystal coating layer, followed by polymerizing the liquid crystal compound, for example, in the presence of a concentration gradient of the chiral agent.

In some embodiments, formation of the TN layer may include irradiating the coating layer of the TN composition with a relatively weak (e.g., low) intensity of UV light to form a concentration gradient of the chiral agent, and irradiating the coating layer having the concentration gradient of the chiral agent with a relatively strong (e.g., high) intensity of UV light to polymerize the components of the composition.

When the coating layer of the TN composition is irradiated with a relatively weak intensity of UV light at a set or predetermined temperature, it is possible to induce the concentration gradient of the chiral agent in the coating layer, that is, a change in concentration of the chiral agent in the coating layer in a set or predetermined direction. By way of example, the concentration gradient of the chiral agent in the coating layer may be formed in a thickness direction of the coating layer. Irradiation with UV light for formation of the concentration gradient of the chiral agent may be performed in the temperature range of, for example, 40° C. to 80° C., or 50° C. to 70° C., or at about 60° C. Furthermore, irradiation with UV light for formation of the concentration gradient of the chiral agent may be performed by irradiating with UV light at wavelengths in the UVA region at a dose of about 10 mJ/cm² to about 500 mJ/cm². For more effective formation of the concentration gradient, the quantity of light (e.g., light dose) may be adjusted to about 50 mJ/cm² to about 400 mJ/cm², about 50 mJ/cm² to 300 mJ/cm², about 50 mJ/cm² to about 200 mJ/cm², about 50 mJ/cm² to about 150 mJ/cm², or about 75 mJ/cm² to about 125 mJ/cm².

After forming the concentration gradient, the TN layer may be formed by irradiating with a sufficient amount of UV light to polymerize the components of the composition. By irradiation with UV light, the coating layer may be formed with a TN region, in which the liquid crystals are secured (e.g., fixed) at different pitches according to the concentration gradient of the chiral agent. Conditions for irradiation with the strong intensity of UV light are not particularly limited so long as irradiation with UV light is performed such that polymerization of the components of the composition can be sufficiently carried out. By way of example, irradiation with UV light may be performed by irradiating with UV light at a dose of about 0.5 J/cm² to 10 J/cm². The wavelength of UV light is not particularly limited so long as sufficient polymerization can be secured, and may include, for example, UV wavelengths in the UVA and UVB regions.

In some embodiments, the coating layer of the TN composition may be formed on a suitable base layer.

In some embodiments, the coating layer of the TN composition may be formed on an alignment layer formed on the base layer.

The alignment layer may be formed, for example, by forming and rubbing a polymer film, such as a polyimide layer, on the base layer, coating a photo-alignment compound thereon, and aligning the photo-alignment compound through irradiation with linearly polarized light, or by an imprinting method, such as a nanoimprinting method. Alternatively, the alignment layer may be formed by alignment through electrostatic attraction by mechanically rubbing the base layer with a rubbing cloth in one direction.

The liquid crystal retardation layer including the TN layer described above may be applied to various applications by itself or in combination with other elements.

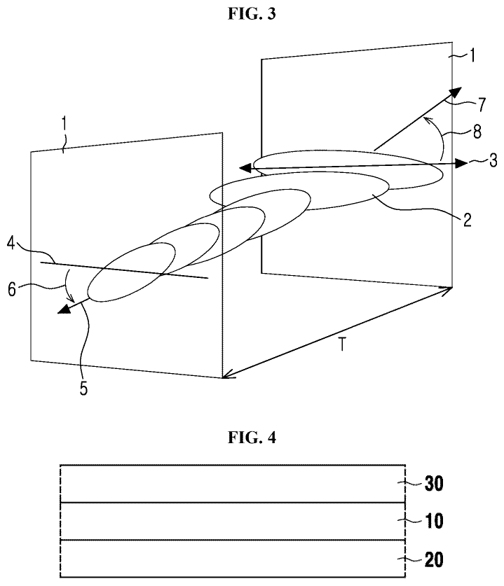

FIG. 2 and FIG. 3 are conceptual diagrams showing liquid crystal alignment states in the liquid crystal retardation layer.

Referring to FIG. 2, the liquid crystal retardation layer may have a twisted alignment state in which twisted nematic liquid crystals 2 are aligned only at an azimuth angle 6 between opposite surfaces 1 facing each other from one surface subjected to alignment treatment 3 to the other surface so as to be parallel to the one surface. In addition, the twisted angles of the liquid crystals may be non-linearly distributed from an initial alignment angle 4 to final alignment angles 5, 6 with respect to (e.g., along) a thickness direction T. Here, a phase difference between a dense (e.g., higher density) portion and a thin (e.g., lower density) portion due to a nonlinear distribution of the liquid crystal retardation layer may be expressed as negative dispersion characteristics, analogous to a retardation layer composed of a half-wavelength (HWP) layer and a quarter-wavelength (QWP) layer with different slow axes. As a result, the liquid crystal retardation layer can easily satisfy Formula 1.

In some embodiments, referring to FIG. 3, which shows an example of another alignment state of the liquid crystals, the liquid crystal retardation layer may have a twisted alignment state in which the twisted nematic liquid crystals 2 are aligned (5) between opposite surfaces 1 facing each other and have alignment angles changing from an initial alignment angle 4 parallel to one surface subjected to alignment treatment 3 to a tilt angle 6 on the other surface so as to be parallel to the thickness direction. In addition, the twisted nematic liquid crystals 2 may also have an azimuth angle 8, which rotates (7) to be parallel to the one surface, together with the tilt angle 6. In addition, the twisted angles of the liquid crystals may be non-linearly distributed with respect to (e.g., along) the thickness direction T. In this embodiment, the retardation layer can easily satisfy Formula 1 by compensating for the out-of-plane retardation due to a tilt component of the liquid crystals while compensating for the in-plane retardation due to an azimuth component of the liquid crystals.

In some embodiments, the thickness of the liquid crystal retardation layer may be greater than or equal to 80%, for example, 90% to 100%, or 100%, of the thickness of the retardation layer.

The polarizing plate may further include a first protective layer disposed on one surface of the polarizer. In some embodiments, the first protective layer may be disposed opposite the liquid crystal retardation layer with reference to the polarizer (e.g., on opposite side of the polarizer from the liquid crystal retardation layer). The polarizing plate may include one or more first protective layers.

### First Protective Layer

The first protective layer serves to protect the polarizer from the external environment while increasing mechanical strength of the polarizing plate.

The first protective layer may include at least one selected from among a protective film and a protective coating layer. The first protective layer may be a liquid crystal layer or a non-liquid crystal layer.

In some embodiments, the first protective layer may include an optically transparent film. For example, the first protective layer may include a film formed of at least one resin selected from among cellulose resins including triacetylcellulose (TAC) and the like, polyester resins including polyethylene terephthalate (PET), polybutylene terephthalate, polyethylene naphthalate (PEN), polybutylene naphthalate, and the like, cyclic olefin polymer (COP) resins, cyclic olefin copolymer (COC) resins, polycarbonate resins, polyether sulfone resins, polysulfone resins, polyamide resins, polyimide resins, polyolefin resins, polyarylate resins, polyvinyl alcohol resins, polyvinyl chloride resins, and polyvinylidene chloride resins.

The polarizing plate may further include a functional coating layer on at least one surface of the first protective layer. For example, the functional coating layer may include an anti-reflection layer, a low-reflectivity layer, a hard-coating layer, a fingerprint-resistant layer, an antiglare layer, a primer layer, and/or the like.

The first protective layer may have a thickness of 5 μm to 120 μm, for example, 40 μm to 90 μm. Within this range, the first protective layer can be suitably used in the polarizing plate.

The polarizing plate may further include a second protective layer on the other surface (e.g., the surface opposite to the one having the first protective layer thereon) of the polarizer. In some embodiments, the second protective layer may be disposed at a side of (e.g., on the same side as) the liquid crystal retardation layer with reference to the polarizer. The polarizing plate may include one or more second protective layers.

### Second Protective Layer

The second protective layer serves to compensate for in-plane retardation and/or out-of-plane retardation.

In some embodiments, the second protective layer may have an in-plane retardation of 10 nm or less, for example, 0 nm to 5 nm, at a wavelength of 550 nm, and an out-of-plane retardation of −100 nm or more, for example, −70 nm to −20 nm, at a wavelength of 550 nm. Within these ranges, the out-of-plane retardation of the polarizing plate can be suitably compensated. For example, the second protective layer may include a positive C retardation layer.

In some embodiments, each of the in-plane retardation and the out-of-plane retardation of the second protective layer may be less than or equal to 10 nm, for example, 0 nm to 5 nm, at a wavelength of 550 nm. Within this range, the second protective layer does not affect reduction in reflectivity at a lateral side of the polarizing plate.

In some embodiments, the second protective layer may have an in-plane retardation of 200 nm to 400 nm, for example, 200 nm to 300 nm, at a wavelength of 550 nm. Within this range, the polarizing plate can achieve further reduction in reflectivity at a lateral side thereof.

The second protective layer may have positive dispersion, negative dispersion, or flat dispersion characteristics.

The second protective layer may include a liquid crystal layer or a non-liquid crystal layer.

The second protective layer may include an optically transparent film. For example, the second protective layer may include a film formed of at least one resin selected from among cellulose resins including triacetylcellulose (TAC) and the like, polyester resins including polyethylene terephthalate, polybutylene terephthalate, polyethylene naphthalate, polybutylene naphthalate, and the like, cyclic olefin polymer (COP) resins, cyclic olefin copolymer (COP) resins, polycarbonate resins, polyether sulfone resins, polysulfone resins, polyamide resins, polyimide resins, polyolefin resins, polyarylate resins, polyvinyl alcohol resins, polyvinyl chloride resins, and polyvinylidene chloride resins.

The polarizer, the liquid crystal retardation layer, the first protective layer, and the second protective layer may be stacked one above another through an adhesive layer and/or a bonding layer.

FIG. 4 is a cross-sectional view of a polarizing plate according to some embodiments of the present disclosure.

Referring to FIG. 4, the polarizing plate may include a polarizer 10; a liquid crystal retardation layer 20 stacked on a lower surface of the polarizer 10; and a protective layer 30 stacked on an upper surface of the polarizer 10. Although not shown in FIG. 4, the polarizing plate may further include an adhesive layer or a bonding layer to bond these layers to each other.

An optical display apparatus according to the present disclosure includes a polarizing plate according to embodiments of the present disclosure. The optical display apparatus may include a light emitting diode display.

Next, the present disclosure will be described in more detail with reference to some examples. However, it should be noted that these examples are provided for illustration only and are not to be construed in any way as limiting the present disclosure.

### Example 1

### Preparation of Polarizer

A polarizer having a total light transmittance of 45% was prepared by stretching a polyvinyl alcohol film (TS #45, thickness: 45 μm, Japan Kuraray Co., Ltd.) to 6 times an initial thickness thereof in an aqueous iodine solution at 55° C. in the MD of the polyvinyl alcohol film.

### Preparation of Liquid Crystal Composition

A mixed solution was prepared by mixing about 40 parts by weight of a bifunctional acrylic twisted nematic liquid crystal compound (LC242, BASF) and about 0.2 parts by weight of a bifunctional acrylic levorotatory chiral agent compound (LC766, BASF) in an organic solvent containing methyl isobutyl ketone (MIBK) and methyl ethyl ketone (MEK) in a weight ratio of 2:1. A liquid crystal composition was prepared by mixing about 1.5 parts by weight of a photoinitiator (IG-907, Ciba-Giegy) and about 0.02 parts by weight of a leveling agent (Tego-Rad 2100, Ciba-Giegy) with the mixed solution. Table 1 below shows the amounts of the chiral agent compounds (unit: parts by weight) relative to 100 parts by weight of the liquid crystal composition.

### Coating of Liquid Crystal Composition

Corona treatment was performed on one surface of a polyethylene terephthalate (PET) film not including a primer layer to impart coatability thereto. Then, an electrostatic alignment layer was formed by rubbing a rubbing cloth on the PET film in one direction (rubbing direction). The prepared liquid crystal composition was coated to a predetermined thickness on the surface of the PET film subjected to alignment treatment by bar coating and was then dried at 60° C. for 2 minutes to form a retardation layer having a dry film thickness of 2.1 μm. A liquid crystal retardation layer was formed on the PET film by pre-curing (dose: 80 mJ/cm²) of the liquid crustal composition using a BL lamp (wavelength: 352 nm) at a temperature of about 60° C., followed by complete curing (dose: 700 mJ/cm²) using a UV irradiation device (metal lamp). The liquid crystal retardation layer had substantially the same thickness as the dry film.

### Manufacture of Polarizing Plate

The liquid crystal retardation layer prepared above was stacked on one surface of the polarizer such that the rubbing direction became parallel to the light absorption axis of the polarizer (MD of the polarizer), followed by removing the PET film. Then, a PET film having an anti-reflection layer (reflectivity: 0.5%, DSG-23, DNP) formed thereon was attached as a first protective layer to the other surface of the polarizer, thereby preparing a polarizing plate with the PET film, the polarizer, and the liquid crystal retardation layer stacked in the stated order.

### Examples 2 and 3

Polarizing plates were prepared in the same manner as in Example 1 except that the thickness of the dry film was changed when forming the liquid crystal retardation layer. The thickness of the dry film was substantially the same as the thickness of the liquid crystal retardation layer.

### Comparative Example 1

A polarizing plate was prepared in the same manner as in Example 1 except that an obliquely stretched olefin polymer (COP) film was used instead of the liquid crystal retardation layer.

### Comparative Examples 2 and 3

Polarizing plates were prepared in the same manner as in Example 1 except that the thickness of the dry film was changed when forming the liquid crystal retardation layer. The thickness of the dry film was substantially the same as the thickness of the liquid crystal retardation layer.

### Comparative Example 4

A polarizing plate was prepared in the same manner as in Example 1 except that the content of the acrylic levorotatory chiral agent was changed as listed in Table 1 when forming the liquid crystal retardation layer. The thickness of the dry film was substantially the same as the thickness of the liquid crystal retardation layer.

### Comparative Example 5

A polarizing plate was prepared in the same manner as in Example 1 except that the acrylic levorotatory chiral agent compound (LC766, BASF) was changed to an acrylic dextrorotatory chiral agent compound (LC756, BASF) when forming the liquid crystal retardation layer. The thickness of the dry film was substantially the same as the thickness of the liquid crystal retardation layer.

Re of the liquid crystal retardation layer was calculated from Mueller Matrix values measured using an AXOSCAN at a wavelength of 550 nm.

The following properties were evaluated on the liquid crystal retardation layers and the polarizing plates of Examples and Comparative Examples and results are shown in Table 1 and FIG. 5 to FIG. 8.

(1) Circular dichroism of liquid crystal retardation layer (unit: mdeg): Circular dichroism (CD, unit: mdeg, interval: 500 mdeg) of each of the liquid crystal retardation layers prepared in Examples and Comparative Examples was evaluated using a Chirascan plus Circular Dichroism spectrometer (Applied Photophysics Co., Ltd.). Spectra were recorded between a wavelength of 600 nm and a wavelength of 290 nm. Scanning was repeated 10 times and the results were averaged.

(2) Value of Formula 1: Circular dichroism (CD, unit: mdeg, interval: 50 mdeg) of the liquid crystal retardation layer according to wavelength (unit: nm, interval: 50 nm) was measured by the method of (1) and a graph of circular dichroism (CD) (Y-axis) according to wavelength (X-axis) was obtained. From the graph, a slope (e.g., percentage slope) between a circular dichroism value at a wavelength of 300 nm and a circular dichroism value at a wavelength of 400 nm was obtained.

(3) Reflected color AACD value: After each of the polarizing plates prepared in Examples and Comparative Examples was attached to an OLED TV panel (OLED65C3FNA, LG Electronics Co., Ltd.) in a non-driven state, the reflected color values a* and b* (CIE 1976) of the optical display apparatus were measured at θ of 8/30/45/60° and at Φ of 0 to 360° in the spherical coordinate system using a DMS display measurement device (Instrument Systems Inc.). The level of chromaticity was evaluated by calculating a chromaticity width according to (a*ₘₐₓ−a*ₘᵢₙ)×(b*ₘₐₓ−b*ₘᵢₙ) from all of the reflected color values a* and b*. An AACD value of 2.5 or less was rated as ⊚, an AACD value of greater than 2.5 and less than or equal to 5.0 was rated as ∘, an AACD value of greater than 5.0 and less than or equal to 5.5 was rated as Δ, and an AACD value of greater than 5.5 was rated as X.

TABLE 1

| | | | Comparative Example | | | | | Example | | |
|---|---|---|---|---|---|---|---|---|---|---|
| | | | 1 | 2 | 3 | 4 | 5 | 1 | 2 | 3 |
| Retardation | Component | | COP | TN | TN | TN | TN | TN | TN | TN |
| layer | | | | liquid | liquid | liquid | liquid | liquid | liquid | liquid |
| | | | | crystals | crystals | crystals | crystals | crystals | crystals | crystals |
| | Dry film thickness | | — | 1.0 | 3.8 | 2.1 | 2.1 | 2.1 | 1.4 | 3.2 |
| | (μm) | | | | | | | | | |
| | Content | Levorotatory | — | 0.5 | 0.5 | 1.0 | — | 0.5 | 0.5 | 0.5 |
| | of chiral | Dextrorotatory | — | — | — | — | 0.5 | — | — | — |
| | agent | | | | | | | | | |
| | (parts by | | | | | | | | | |
| | weight) | | | | | | | | | |
| | In-plane | @550 nm | 141 | 101 | 138 | 133 | 148 | 142 | 134 | 132 |
| | retardation | | | | | | | | | |
| | (nm) | | | | | | | | | |
| | CD | @300 nm | −12 | −337 | −2712 | −2592 | 3121 | −1509 | −669 | −2381 |
| | (mdeg) | @400 nm | −9 | −42 | −215 | −169 | 138 | −127 | −109 | −176 |
| | Formula 1 | | 0.03 | 2.9 | 25.0 | 24.2 | 29.8 | 13.8 | 5.6 | 22.1 |
| Reflected | AACD | | 5.9 | 6.7 | 8.1 | 6.3 | 8.7 | 2.1 | 3.4 | 4.6 |
| color value | | | | | | | | | | |
| Reflected | Evaluation | | X | X | X | X | X | ⊚ | ◯ | ◯ |
| color value | | | | | | | | | | |

As shown in Table 1, the polarizing plates of Examples achieved a good reflected color value (AACD) of less than 5, as shown in FIG. 5 and FIG. 6, by adjusting the slope of the circular dichroism (CD) value according to Formula 1 to a value in the range of 5 to 23. Accordingly, the polarizing plates according to the present disclosure can achieve improvement in processability, reliability and economic feasibility without a cumbersome process of measuring the twisted angle of liquid crystals, as exemplified in FIG. 2 or FIG. 3, at each height through a polarization microscope (POM), and can also achieve significant improvement in screen quality through improvement in black visibility.

Conversely, the polarizing plates of Comparative Examples failing to satisfy the conditions for the present disclosure had a poor reflected color value (AACD) of greater than 5.5, as shown in FIG. 7 and FIG. 8, and thus provided poor black visibility.

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Here, unless otherwise defined, the listing of steps, tasks, or acts in a particular order should not necessarily means that the invention or claims require that particular order. That is, the general rule that unless the steps, tasks, or acts of a method (e.g., a method claim) actually recite an order, the steps, tasks, or acts should not be construed to require one.

A person of ordinary skill in the art, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It should be understood that various modifications, changes, alterations, and equivalent embodiments can be made by those skilled in the art without departing from the spirit and scope of the disclosure.

What is claimed is:

1. A polarizing plate comprising:
a polarizer; and
a retardation layer on one surface of the polarizer,
wherein the retardation layer comprises a liquid crystal retardation layer, the liquid crystal retardation layer satisfying Formula 1:
$$5 \leq \vert ( CD ( 400 nm ) - CD ( 300 nm ) ) / 100 \vert \leq 23 , \qquad ( 1 )$$
where CD(400) is a circular dichroism value, in unit of mdeg, of the liquid crystal retardation layer at a wavelength of 400 nm, and
CD(300) is a circular dichroism value, in unit of mdeg, of the liquid crystal retardation layer at a wavelength of 300 nm.

2. The polarizing plate as claimed in claim 1, wherein the liquid crystal retardation layer has a CD(300) value of −2,500 mdeg to −500 mdeg and a CD(400) value of −500 mdeg to 0 mdeg.

3. The polarizing plate as claimed in claim 1, wherein the liquid crystal retardation layer has an in-plane retardation of 100 nm to 155 nm at a wavelength of 550 nm.

4. The polarizing plate as claimed in claim 1, wherein the liquid crystal retardation layer comprises a twisted nematic liquid crystal layer.

5. The polarizing plate as claimed in claim 1, wherein the liquid crystal retardation layer has a thickness of 10 μm or less.

6. The polarizing plate as claimed in claim 1, wherein the liquid crystal retardation layer has a thickness of greater than 1.0 μm and less than or equal to 3.5 μm.

7. The polarizing plate as claimed in claim 1, wherein the liquid crystal retardation layer comprises a dry or cured product of a composition comprising a twisted nematic liquid crystal compound and a chiral agent.

8. The polarizing plate as claimed in claim 7, wherein the chiral agent comprises an acrylic levorotatory chiral agent.

9. The polarizing plate as claimed in claim 8, wherein the acrylic levorotatory chiral agent is 0.001 parts by weight to 10 parts by weight in amount relative to 100 parts by weight of the liquid crystal compound.

10. The polarizing plate as claimed in claim 8, wherein the acrylic levorotatory chiral agent is 0.1 parts by weight to 0.5 parts by weight in amount relative to 100 parts by weight of the liquid crystal compound.

11. The polarizing plate as claimed in claim 1, wherein the liquid crystal retardation layer has a thickness greater than or equal to 80% of a thickness of the retardation layer.

12. The polarizing plate as claimed in claim 1, further comprising:
at least one of a first protective layer or a second protective layer on the polarizer.

13. An optical display apparatus comprising the polarizing plate as claimed in claim 1.
